(19) United States
(12) Patent Application Publication
(10) Pub. No.: US 2016/0219646 A1
(43) Pub. Date: Jul. 28, 2016

(54) METHOD FOR PRESERVING A RADIO RESOURCE CONTROL STATE OF A USER EQUIPMENT

(71) Applicant: Samsung Electronics Co., Ltd., Gyeonggi-do (KR)

(72) Inventors: Ananth Kumar RAMASAMY, Bangalore (IN); Diwakar Sharma, Bangalore (IN); Umasankar Ceendhralu Baskar, Bangalore (IN)

(73) Assignee: Samsung Electronics Co., Ltd.

(21) Appl. No.: 14/713,398

(22) Filed: May 15, 2015

(30) Foreign Application Priority Data
Jan. 22, 2015 (IN) 322/CHE/2015

(51) Int. Cl. H04W 76/04

(52) U.S. Cl. CPC H04W 76/046

(57) ABSTRACT

Methods and apparatuses are provided for preserving a Radio Resource Control (RRC) state of a User Equipment (UE). The UE receives, from a radio network controller, a physical channel reconfiguration message for transitioning the RRC state of the UE. A

Circuit Switching (CS) event is detected at the UE. A physical channel reconfiguration failure message associated with a failure cause to preserve the RRC state of the UE, is transmitted from the UE to the radio network controller.

### PRIORITY

This application claims priority under 35 U.S.C. §119(a) to Indian Patent Application No. 322/CHE2015, filed on Jan. 22, 2015, the content of which is incorporated herein by reference.

### BACKGROUND

1. Field of the Disclosure

The embodiments disclosed herein relate to mobile communication, and more particularly, to a method and system for preserving a radio resource control state of a user equipment.

2. Description of the Related Art

When a user equipment (UE) communicates with a Universal Terrestrial Radio Access Network (UTRAN), a race condition scenario may arise. During the race condition scenario, the UTRAN may instruct the UE to transition from a Radio Resource Control (RRC) state (event 1), while the UE triggers a Circuit Switching (CS) event (event 2). Since both event 1 and event 2 occur at the same time, the UTRAN is required to either continue with the establishment of a connection for the CS event initiated by the UE, or reject the establishment of the connection for the CS event. In both the cases, mobile signaling and a time required to set up the CS event increase, thereby affecting the overall user experience. The 3rd Generation Partnership Project (3GPP) specification does not provide a solution for the race condition scenario.

### SUMMARY

Embodiments have been made to address at least the above problems and/or disadvantages and to provide at least the advantages described below. Accordingly, an aspect of the present disclosure provides a system and method for preserving an RRC state of a UE.

Another aspect of the embodiments herein provides a mechanism to receive, at the UE, from a radio network controller, a physical channel reconfiguration message for transition of the RRC state.

An additional aspect of the embodiments herein provides a mechanism to detect a CS event at the UE.

A further aspect of the embodiments herein provides a method in which the UE transmits a physical channel reconfiguration failure message to the radio network controller when the CS event is detected at the UE.

According to an embodiment, a method is provided for preserving an RRC state of a UE. The UE receives, from a radio network controller, a physical channel reconfiguration message for transitioning the RRC state of the UE. A CS event is detected at the UE. A physical channel reconfiguration failure message associated with a failure cause to preserve the RRC state of the UE, is transmitted from the UE to the radio network controller.

### BRIEF DESCRIPTION OF THE DRAWINGS

The above and other aspects, features, and advantages of the embodiments herein will be more apparent from the following description when taken in conjunction with accompanying drawings in which:

FIG. 1 is a sequence diagram illustrating a race condition scenario, wherein a UE initiates a Mobile Originated (MO) CS event, and UTRAN triggers a transition of an RRC state of the UE at the same time;

FIG. 2 is a sequence diagram illustrating a mechanism for managing the MO CS event initiated by the UE when the UTRAN triggers a transition of the RRC state of the UE;

FIG. 3 is a sequence diagram illustrating another mechanism for managing the MO CS event initiated by the UE when the UTRAN triggers a transition of the RRC state of the UE;

FIG. 4 is a block diagram illustrating the UE for preserving the RRC state of the UE, in accordance with the embodiments described herein;

FIG. 5 is a sequence diagram illustrating a method for preserving the RRC state of the UE using a new failure cause, in accordance with the embodiments described herein;

FIG. 6 is a sequence diagram illustrating a method for preserving the RRC state of the UE using an existing failure cause, in accordance with the embodiments described herein;

FIG. 7 is a flow diagram illustrating a method for preserving the RRC state of the UE using a new failure cause, in accordance with the embodiments described herein;

FIG. 8 is a flow diagram illustrating a method for preserving the RRC state of the

UE using an existing failure cause, in accordance with the embodiments described herein; and

FIG. 9 is a diagram illustrating a computing environment implementing the method for preserving the RRC state of the UE, according to the embodiments described herein.

### DETAILED DESCRIPTION

Embodiments are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

Herein, reference may be made to “an”, “one”, or “some” embodiment(s). This does not necessarily imply that each such reference is to the same embodiment(s), or that the feature only applies to a single embodiment. Single features of different embodiments may also be combined to provide other embodiments.

As used herein, the singular forms “a”, “an”, and “the” are intended to include the plural forms as well, unless expressly stated otherwise. It will be further understood that the terms “includes”, “comprises”, “including”, and/or “comprising”, when used herein, specify the presence of stated features, integers, steps, operations, elements, and/or components, but do not preclude the presence or addition of one or more other features integers, steps, operations, elements, components, and/or groups thereof As used herein, the term “and/or” includes any and all combinations and arrangements of one or more of the associated listed items.

Unless otherwise defined, all terms (including technical and scientific terms), as used herein, have the same meanings as those commonly understood by one of ordinary skill in the art to which this disclosure pertains. It will be further understood that terms, such as those defined in commonly used dictionaries, should be interpreted as having a meaning that is consistent with their meaning in the context of the relevant art, and will not be interpreted in an idealized or overly formal sense unless expressly so defined herein.

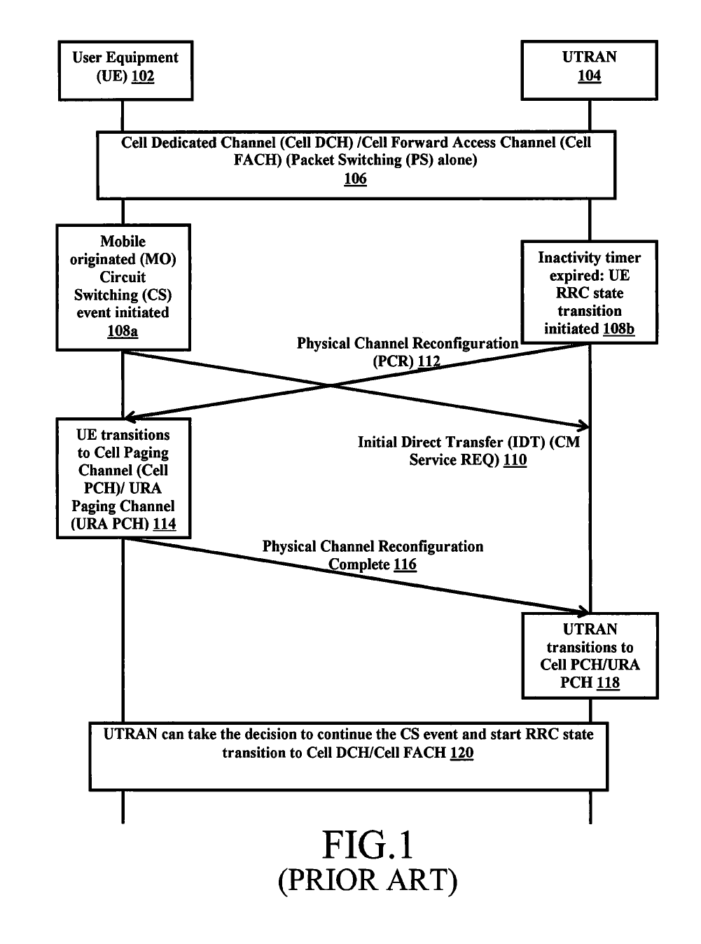

FIG. 1 is a sequence diagram illustrating the race condition scenario, wherein a UE initiates a CS event, and a UTRAN triggers a transition of an RRC state of the UE at the same time. In the FIG. 1, a UE 102 is in a connected mode. The RRC state of the UE 102 may be one of a Cell Dedicated Channel (CELL DCH) or a Cell Forward Access Channel (CELL FACH). While in the connected mode, Packet Switching (PS) data flow is ongoing, in step 106. When the PS data flow does not occur between the UE 102 and a UTRAN 104 for a specified time interval, an inactivity timer expires in the UTRAN 104. Upon expiration of the inactivity timer, in step 108b, the UTRAN 104 initiates a transition of the RRC state of the UE 102 from CELL DCH or CELL FACH to one of a Cell Paging Channel (CELL PCH) or UTRAN Registration Area (URA) Paging Channel (URA PCH) (event 2).

At the same time, the UE 102 initiates the CS event (event 1), in step 108a. The CS event is an MO CS event. The CS event may be a CS call or a CS Short Message Service (SMS). In order to initiate the CS event, the UE 102 transmits a Connection Management (CM) service request through an Initial Direct Transfer (IDT) message to the UTRAN 104, in step 110. Further, in step 112, the UTRAN 104 transmits a Physical Channel Reconfiguration (PCR) message for initiating transition of the RRC state of the UE 102. In step 114, the UE transitions to one of the CELL PCH or the URA PCH in response to the PCR message. In step 116, the UE 102 transmits a PCR complete message, which indicates to the UTRAN 104 that the PCR is complete. In response to the PCR complete message, the UTRAN 104 transitions to one of the CELL PCH or the URA PCH, in step 118. The UTRAN 120 decides whether to continue with the CS event and start RRC state transition to the Cell DCH/Cell FACH, in step 120.

Event 1 occurs at the UE 102, and event 2 occurs at an entity of the UTRAN 104, at the same time. The UTRAN 104 triggers a downlink RRC message for transition of the RRC state and the UE 102 triggers an uplink IDT message at the same time. Since both RRC entities, (the UTRAN 104 and the UE 102) transmit messages to a lower layer of transmission before receiving a message from a peer entity (the UTRAN 104 or the UE 102), the race condition scenario occurs. The UTRAN 104 detects the race condition when the UTRAN 104 receives the IDT message after sending the downlink message for the transition of the RRC state. The UE 102 detects the race condition when the UE 102 receives the downlink message for the transition of the RRC state after transmitting the IDT message for the CS event to the lower layers. Since the UTRAN 104 controls the establishment of the connection between the UE 102 and the UTRAN 104, the UTRAN 104 may accept the IDT message or reject the IDT message.

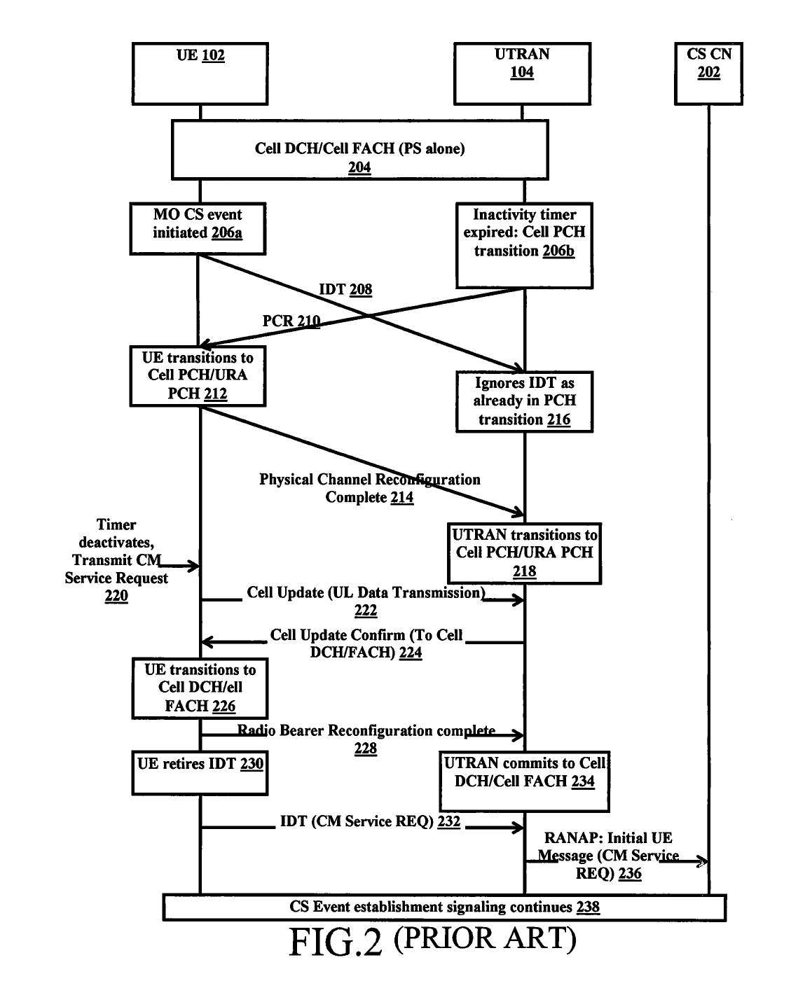

FIG. 2 is a sequence diagram illustrating a mechanism for managing the MO CS event initiated by the UE, when the UTRAN triggers the transition of the RRC state of the UE. Initially, the UE 102 is in a connected mode. The RRC state of the UE 102 may be one of the CELL DCH and the CELL FACH. While in the connected mode, the PS data flow is ongoing. When the PS data flow does not occur between the UE 102 and the UTRAN 104 for the specified time interval, the inactivity timer expires in the UTRAN 104. Upon expiration of the inactivity timer, in step 206b, the UTRAN 104 initiates the transition of the RRC state of the UE 102 from CELL DCH or CELL FACH to one of the CELL PCH or the URA PCH (event 2).

At the same time, the UE 102 initiates the CS event (event 1), in step 206a. In order to initiate the CS event, the UE 102 transmits the CM service request to the UTRAN 104 through the IDT message, in step 208. Further, in step 210, the UTRAN 104 transmits the

PCR message to the UE 102 for initiating transition of the RRC state of the UE 102. In step 212, the UE transitions to one of the CELL PCH or the URA PCH in response to the PCR message. In step 214, the UE 102 transmits the PCT complete message indicating to the UTRAN 104 that the PCR is complete by transmitting the PCR complete message.

In step, 216, the UTRAN 104 ignores or rejects the IDT message, since the transition of the RRC state is initiated before receiving the IDT message. In step 218, the UTRAN 104 transitions to one of the CELL PCH or the URA PCH.

In step 220, the UE 102 may retransmit the CM service request based on a type of service requested by a user. The CM service request may be retransmitted upon expiration of a timer T3230. The default value in the timer is set to 15 seconds. Upon retransmitting the CM service request, the UE 102 triggers transmission of the IDT to the UTRAN 104. In step 222, the UE 102 triggers transmission of a cell update message with an ‘UplinkDataTansmission’ cause message using Random Access Channel (RACH) resources, since the RRC state of the UE 102 is CELL PCH or URA PCH. In an enhanced CELL PCH state, there is a possibility of direct signaling between the UE 102 and the UTRAN 104 without a cell update procedure. However, when at least one of the UE 102 or the UTRAN 104 does not support the enhanced CELL PCH state, the cell update procedure is required. Upon receiving a cell update message corresponding to the cell update triggered by the UE 102, the UTRAN 104 configures radio resources and sends information of the RRC state (CELL DCH or CELL FACH) to the UE 102 in a cell update confirm message, in step 224. Additionally, in step 226, upon receiving the cell update confirm message, the UE 102 changes the RRC state from the CELL PCH or the URA PCH to the CELL DCH or the CELL FACH. Further, in step 228, the UE 102 triggers a Radio Bearer Reconfiguration Complete (RBRC) message for transmission to the UTRAN 104.

The UE retires the IDT, in step 230. The IDT message is retransmitted by the UE 102 to establish the CS signaling, in step 232. The UTRAN 104 commits to the CELL DCH or the CELL FACH to proceed with the CS establishment, in step 234. The UTRAN 104 transmits the CM service request to a Core Network (CN) 202 through a Radio Access Network Application Part (RANAP) protocol, in step 236. The CS signaling continues for establishment of the CS event, in step 238.

In the method of FIG. 2, the CM service request is retransmitted after the timer deactivates. Thus, the UE 102 has to wait in order to initiate the CS event leading to a delay in establishment of the CS call. Thus, the Call Setup Time (CST) is affected. If the UE 102 does not retransmit the CM service request, the CS call may not be established, leading to a reduction in a Call Success Ratio (CSR). Further, the UE 102 is required to use the RACH resources, since the RRC state of the UE 102 is the CELL PCH or the URA PCH. Due to the fact that the RACH is an open loop power control, the usage of the RACH leads to an increase in power consumption at the UE 102. Thus, the RACH resources are not utilized effectively.

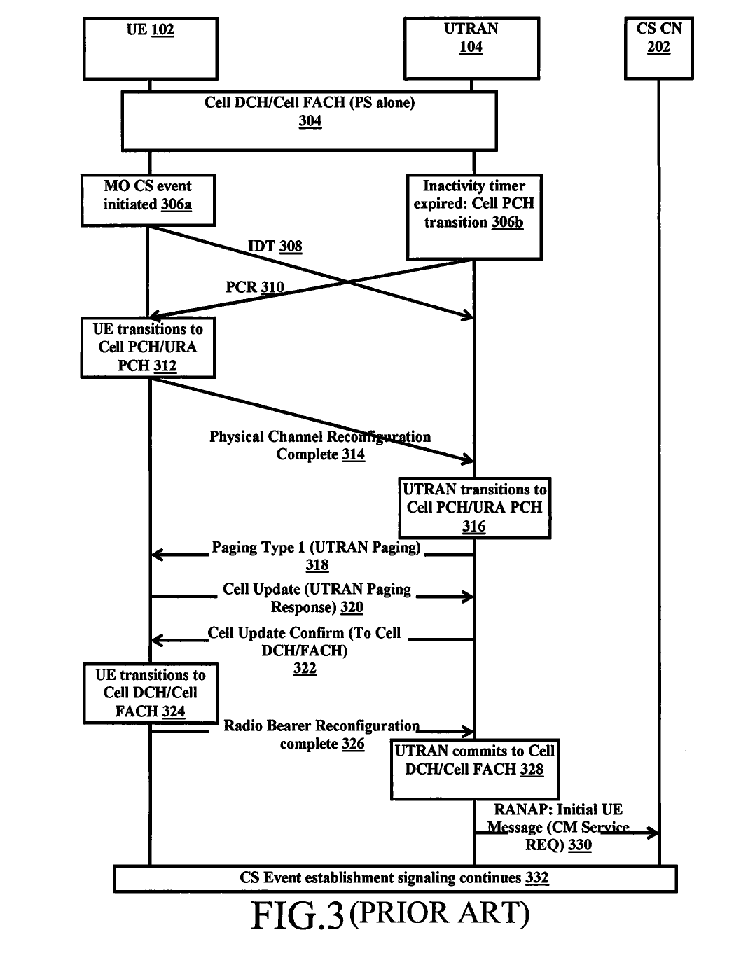

FIG. 3 is a sequence diagram illustrating another mechanism for managing the MO CS event initiated by the UE when the UTRAN triggers the transition of the RRC state of the UE. Initially, the UE 102 is in a connected mode. Steps 304, 306a, 306b, 308, 310, 312, and 314 of FIG. 3 are substantially identical to steps 204, 206a, 206b, 208, 210, 212, and 214 of FIG. 2, which are described in detail above. In step 316, the UTRAN 104 transitions to one of the CELL PCH or the URA PCH.

The UTRAN 104 accepts the CS call initiated by the UE 102. In order to honor or accept the CS call initiated by the UE 102, the UTRAN 104 wakes back the UE 102 using a paging type 1 message, in step 318. The UTRAN 104 sends the paging type 1 message after receiving the confirmation of the transition of the RRC state of the UE 102. The confirmation of the transition may be sent through an uplink RRC confirmation message or the PCR complete message. The uplink RRC confirmation message may be one of a Physical Channel Reconfiguration Complete message, a Transport Channel Reconfiguration Complete message, or a Radio Bearer Reconfiguration Complete message.

Upon receiving the paging type 1 message, the UE 102 responds with a cell update message using the RACH resources, in step 320. After receiving the cell update message, the UTRAN 104 configures the radio resources and sends the CELL DCH or the CELL FACH state information to the UE 102 in a cell update confirm message, in step 322. Upon receiving the cell update confirm message, the UE 102 transitions from the CELL PCH or the URA PCH to the CELL DCH or the CELL FACH, in step 324. After the state transition, the UE 102 triggers the RBRC to the UTRAN 104, in step 326. The UTRAN 104 commits to the CELL DCH and the CELL FACH, in step 328. In step 330, the UTRAN 104 transmits the CM service request to the CN 202 through the RANAP protocol. Further, in step 332, signaling continues for establishment of the CS event.

In the method illustrated in FIG. 3, upon receiving the uplink confirmation message, the UTRAN 104 pages the UE 102. Upon receiving the paging message, the UE 102 performs the cell update and the UTRAN 104 switches the UE 102 to the CELL FACH or the CELL DCH state. Thus, the state transition of the UE 102 requires additional signaling. Moreover, the state transition leads to an increase in the CST, thereby affecting performance of the UE 102. Further, the UE 102 is required to use the RACH resources, since the RRC state of the UE 102 is the CELL PCH or the URA PCH. Since the RACH is an open loop power control, the usage of the RACH leads to an increase in power consumption at the UE 102. Thus, the RACH resources are not utilized effectively.

The embodiments described herein provide a method and a UE configured for preserving an RRC state of the UE.

When the CS event is detected at the UE, the UE is configured to transmit a PCR failure message to the radio network controller. The radio network controller is configured to roll back to one of the CELL DCH state or the CELL FACH state in response to receiving the PCR failure message associated with the failure cause.

In one embodiment, the failure cause is ‘CS establishment ongoing’. In another embodiment, the failure cause is one of ‘configuration unsupported’ and ‘incompatible simultaneous reconfiguration’.

Unlike the methods illustrated in FIGS. 2 and 3, the method of the embodiments reduces the CST by minimizing signaling during a race condition scenario. Further, unlike the methods of FIGS. 2 and 3, the method of the embodiments increases a CSR since the UE transmits the PCR failure message in response to the PCR message, as an alternative to the transition of the RRC state from one of the CELL DCH or the CELL FACH to the CELL PCH or the URA PCH. Moreover, as the CST is reduced and the CSR is increased, user experience is enhanced.

Further, since the UE rejects the transition of the RRC state initiated by the UTRAN, the UE is not necessitated to use the RACH resources for reinitiating the CS event. Thus, the RACH resources are utilized effectively. Further, since the UTRAN is not required to use the paging channel for a cell update procedure, the paging channel is utilized effectively.

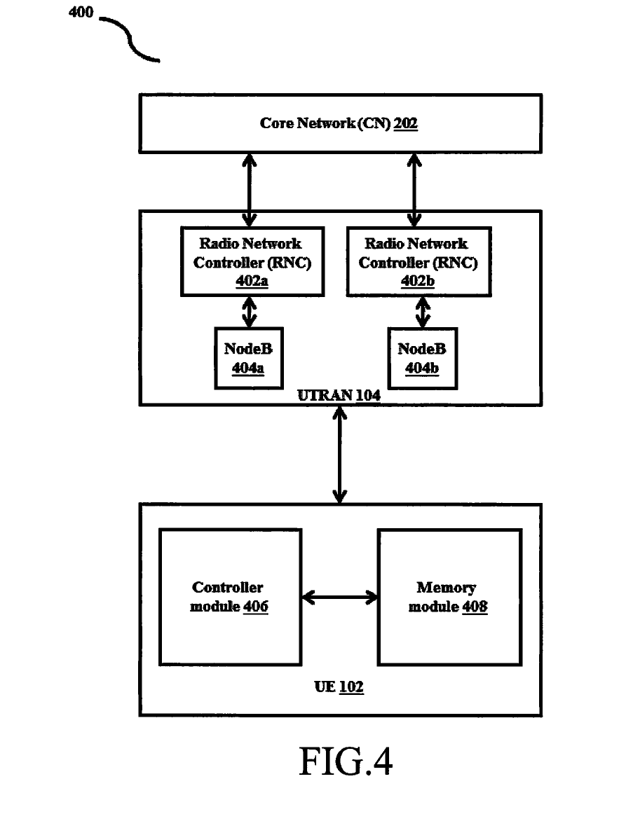

FIG. 4 is a block diagram illustrating a UE for preserving a RRC state of the UE, in accordance with the embodiments described herein. The UE 102 can be embodied as, for example, a cellular phone, a smart phone, a wireless organizer, a personal digital assistant, a tablet, a handheld wireless communication device, or the like.

As illustrated in the FIG. 4, the UE 102 is in communication with the UTRAN 104. The UTRAN 104 may include multiple base stations. The multiple base stations included in the UTRAN 104 are a NodeB 404a and a NodeB 404b. The NodeB 404a interacts with a Radio Network Controller (RNC) 402a, and the NodeB 404b interacts with an RNC 402b. The RNC 402a controls the NodeB 404a, and the RNC 402b controls the NodeB 404b.

Further, the UTRAN 104 is connected to the CN 202. The RNC 402a and the RNC 402b may be collectively referred to as the RNC herein. The UTRAN 104 may be further configured to include a transceiver that performs transmitting and receiving steps.

In an embodiment, the UE 102 is configured to include a controller module 406 and a memory module 408. The controller module 406 can be configured to receive, from the RNC, a PCR message for transition of the RRC state. The RRC state is one of a CELL DCH state or a CELL FACH state. The PCR message is transmitted by the RNC upon expiration of an inactivity timer. The PCR message is transmitted by the RNC while the UE 102 transmits an IDT message to initiate a CS event. The PCR message is transmitted by the RNC for transition of the RRC state to one of a CELL PCH state or a URA PCH state.

Further, the controller module 406 can be configured to detect the CS event at the UE 102. The CS event may be any MO activity. The MO activity may be an MO voice call or an MO SMS. The MO activity may alternatively be referred to as a CS call herein.

In an embodiment, the CS event may be detected prior to receiving the PCR message from the RNC. In another embodiment, the CS event may be detected after receiving the PCR message from the RNC.

Further, the controller module 406 can be configured to transmit a PCR failure message to the RNC 402 when the CS event is detected at the UE 102. The PCR failure message is associated with a failure cause to preserve the RRC state of the UE 102.

In an embodiment, the failure cause may be a ‘CS establishment ongoing’. In another embodiment, the failure cause may be one of a ‘configuration unsupported’ and an ‘incompatible simultaneous reconfiguration’.

The RNC can be configured to roll back to one of the CELL DCH state or the CELL FACH state in response to receiving the PCR failure message associated with the failure cause.

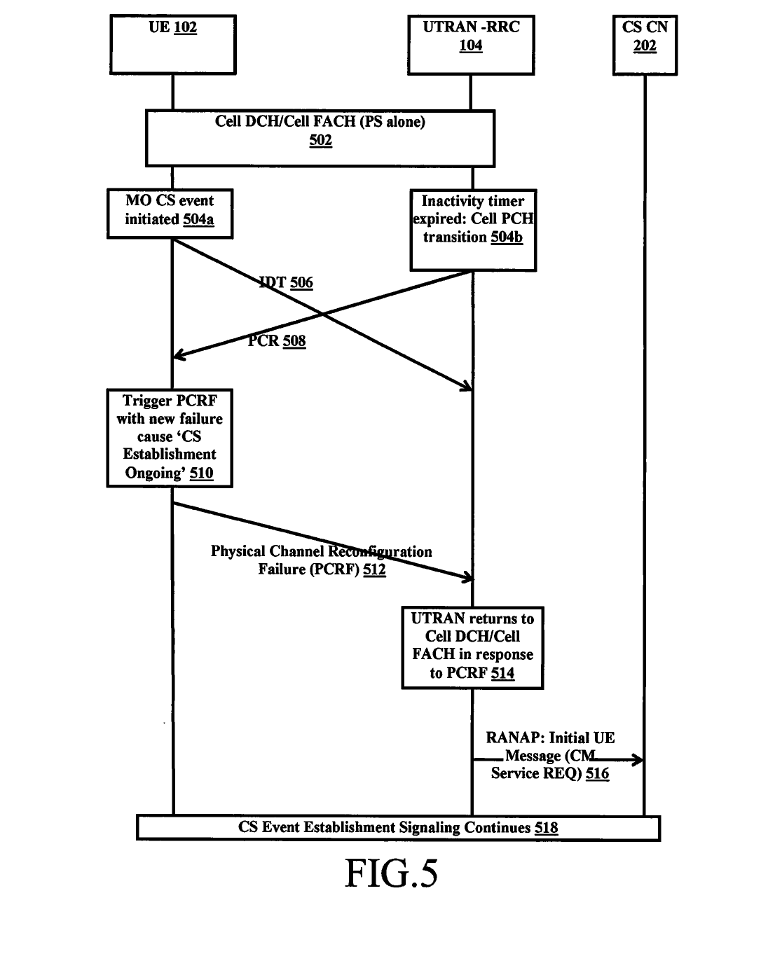

FIG. 5 is a sequence diagram illustrating a method for preserving the RRC state of the UE using a new failure cause, in accordance with the embodiments described herein.

The UE 102 is in a connected mode. The RRC state of the UE 102 may be one of the CELL DCH or the CELL FACH. While in the connected mode, PS data flow is ongoing, in step 502. When the PS data flow does not occur between the UE 102 and the UTRAN 104 for a specified time interval, an inactivity timer expires in the UTRAN 104. Upon expiration of the inactivity timer, the UTRAN 104 initiates the transition of the RRC state of the UE 102 from the CELL DCH or CELL FACH to one of the CELL PCH or the URA PCH (event 2), in step 504b. At the same time, the UE 102 initiates the CS call (event 1), in step 504a. In order to initiate the CS call, the UE 102 transmits a CM service request to the UTRAN 104 through the IDT message, in step 506.

After the UE 102 submits the IDT message to lower layers for transmission, the UE 102 receives a downlink RRC message for transition of the RRC state, in step 508. The transition of the RRC state may be one of a Physical Channel Reconfiguration, Transport Channel Reconfiguration, or Radio Bearer Reconfiguration. In step 510, the UE 102 rejects the transition of the RRC state by triggering a Physical Channel Reconfiguration Failure (PCRF). The PCRF may be triggered by sending a failure uplink RRC message, in step 512. The failure uplink RRC message may be associated with one of a PCRF, Transport Channel Reconfiguration Failure, and Radio Bearer Reconfiguration Failure. In step 510, the UE 102 may trigger the PCRF by associating the PCRF with a new failure cause. The new failure cause may be ‘CS Establishment Ongoing’. Since the PCRF is triggered by the UE 102 in response to the PCR, the UE 102 remains in the CELL DCH or the CELL FACH RRC state.

After receiving the PCRF with the failure cause of ‘CS Establishment Ongoing, the UTRAN 104 returns to a previous RRC state, in step 514. The previous RRC state may be one of the CELL DCH or the CELL FACH. Further, in step 516, the UTRAN 104 processes the initial UE message with the CN 202. The Initial UE message is the stored IDT message received from the UE 102 for initiating the CS call. The IDT message may be processed with the CN 202 through a Radio Access Network Application Part (RANAP) protocol. In step 518, CS signaling continues for establishment of the CS event or the CS call.

In the method illustrated in the FIG. 5, the UE 102 is not required to retransmit the CM service request to initiate the CS call, since the UE 102 rejects the PCR and triggers the PCRF. Thus, the additional signaling required for a cell update procedure and the transition of the RRC state is eliminated. Further, the utilization of the RACH resources may be minimized, since the cell update procedure and the state transition are avoided. Because the RACH is an open loop power control, by minimizing the RACH utilization, and reducing the signaling message processing at the UE 102, the power consumption at the UE 102 is also reduced.

Moreover, since the initial CS establishment is successful due to rejection of the transition of the RRC state by the UE 102, a CST is reduced and a CSR is increased, thereby enhancing the user experience.

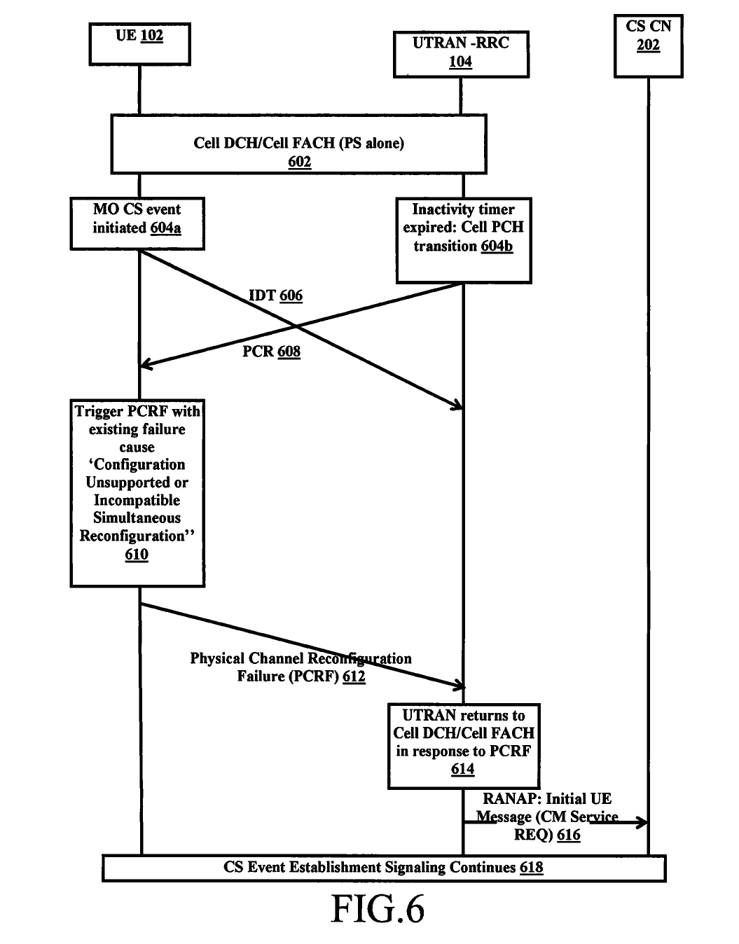

FIG. 6 is a sequence diagram illustrating a method for preserving the RRC state of the UE using an existing failure cause, in accordance with the embodiments described herein.

Steps 602, 604a, 604b, 606, and 608 in FIG. 6 are substantially identical to steps 502, 504a, 504b, 506, and 508 in FIG. 5, which are described in detail above. In step 610, the UE 102 rejects the transition of the RRC state by triggering the PCRF. The PCRF may be triggered by sending the failure uplink RRC message, in step 612. The failure uplink RRC message may be associated with one of the PCRF, Transport Channel Reconfiguration Failure, and Radio Bearer Reconfiguration Failure. In step 610, the UE 102 may trigger the PCRF by associating the PCRF with an existing failure cause. The existing failure cause may be one of a ‘configuration unsupported’ or an ‘incompatible simultaneous reconfiguration’. Since the PCRF is triggered by the UE 102, the UE 102 remains in the CELL DCH or the CELL FACH RRC state.

After receiving the PCRF with the existing failure cause ‘configuration unsupported’ or ‘incompatible simultaneous reconfiguration’, the UTRAN 104 returns to the previous RRC state, in step 614. The previous RRC state may be one of the CELL DCH or the CELL FACH. Further, in step 616, the UTRAN 104 processes the initial UE message with the CN 202. The initial UE message is the stored IDT message received from the UE 102 for initiating the CS call. The IDT message may be processed with the CN 202 through the RANAP protocol. In step 618, CS signaling continues for establishment of the CS event or the CS call.

In the method illustrated in FIG. 6, the UE 102 is not required to retransmit the CM Service Request to initiate the CS call, since the UE 102 rejects the PCR and triggers the PCRF. Thus, the additional signaling required for a cell update procedure and the transition of the RRC state is eliminated. Further, the utilization of the RACH resources may be minimized since the cell update procedure and the state transition are avoided. Because the RACH is an open loop power control, by minimizing the RACH utilization and reducing the signaling message processing at the UE 102, power consumption at the UE 102 is also reduced.

Moreover, since initial CS establishment is successful due to rejection of the transition of the RRC state, the CST is reduced and the CSR is increased, thereby enhancing the overall user experience.

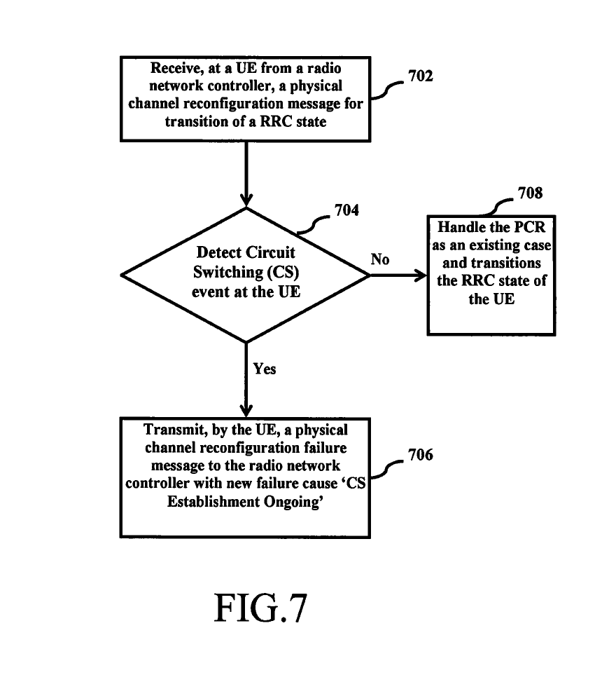

FIG. 7 is a flow diagram illustrating a method for preserving the RRC state of the UE using a new failure cause, in accordance with the embodiments described herein. In step 702, the UE 102 receives the PCR message for transition of the RRC state, from the RNC. The controller module 406 may receive the PCR message. Further, in step 704, it is determined whether the CS event is detected at the UE 102. The controller module 406 may detect the CS event.

If the CS event is detected, the physical channel reconfiguration failure message is transmitted to the RNC, in step 706. The controller module 406 may transmit the physical channel reconfiguration failure message. The physical channel reconfiguration failure message is associated with the failure cause to preserve the RRC state of the UE 102. The failure cause is ‘CS establishment ongoing’.

If the CS event is not detected, the UE transitions to one of the CELL PCH or the URA PCH, in step 708, in response to the PCR message. In an embodiment, the controller module 406 may control transitioning to one of the CELL PCH or the URA PCH in response to the PCR message.

The various actions, acts, blocks, steps, and the like in the method of FIG. 7 may be performed in the order presented, in a different order, or simultaneously. Further, in some embodiments, some actions, acts, blocks, steps, and the like may be omitted, added, modified, skipped, and the like without departing from scope of the embodiments herein.

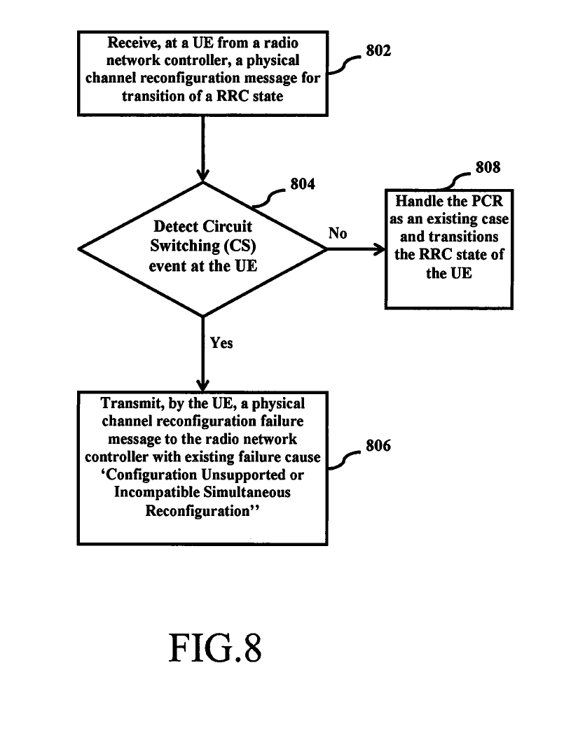

FIG. 8 is a flow diagram illustrating a method for preserving the RRC state of the UE 102 using an existing failure cause, in accordance with the embodiments described herein. In step 802, the UE 102 receives the PCR message for transition of the RRC state. The controller module 406 may receive the PCR message. Further, in step 804, it is determined whether the CS event is detected at the UE. The controller module 406 may detect the CS event.

If the CS event is detected, the UE 102 transmits the physical channel reconfiguration failure message to the RNC 402, in step 806. The controller module 406 may transmit the physical channel reconfiguration failure message. The physical channel reconfiguration failure message is associated with the failure cause to preserve the RRC state of the UE 102. The failure cause is one of ‘configuration unsupported’ and ‘incompatible simultaneous reconfiguration’.

If the CS event is not detected, the UE 102 is transitioned to one of the CELL PCH or the URA PCH, in step 808, in response to the PCR message. In an embodiment, the controller module 406 controls transitioning to one of the CELL PCH or the URA PCH in response to the PCR message.

The various actions, acts, blocks, steps, and the like in the method of FIG. 8 may be performed in the order presented, in a different order, or simultaneously. Further, in some embodiments, some actions, acts, blocks, steps, and the like may be omitted, added, modified, skipped, and the like without departing from scope of the disclosure.

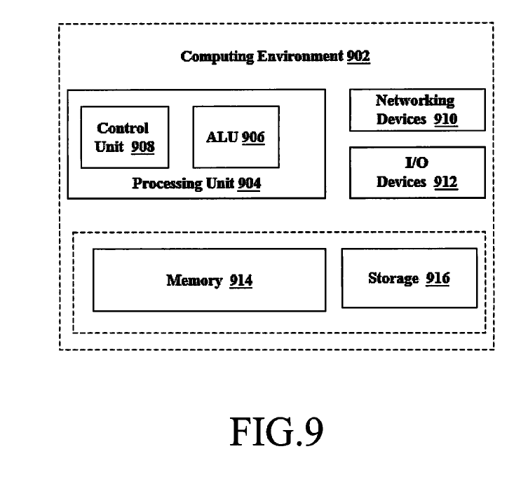

FIG. 9 is a diagram illustrating a computing environment implementing the method for preserving the RRC state of the UE, according to the embodiments described herein. A computing environment 902 includes at least one processing unit 904, which is equipped with a control unit 908 and an Arithmetic Logic Unit (ALU) 906, a memory 914, a storage 916, a plurality of networking devices 910, and a plurality Input/Output (I/O) devices 912.

The processing unit 904 is responsible for processing the instructions of the algorithm. The processing unit 904 receives commands from the control unit 908 in order to perform its processing. Further, any logical and arithmetic operations involved in the execution of the instructions are computed using the ALU 906.

The overall computing environment 902 can be composed of multiple homogeneous or heterogeneous cores, multiple CPUs of different kinds, special media and other accelerators. The processing unit 904 is responsible for processing the instructions of the algorithm. Further, the plurality of processing units 904 can be located on a single chip or over multiple chips.

The algorithm, which includes instructions and codes required for the implementation, is stored in the memory 914, the storage 916, or both. At the time of execution, the instructions can be fetched from the corresponding memory 914 or storage 916, and executed by the processing unit 904.

In hardware implementations, various networking devices 910 or external I/O devices 912 can be connected to the computing environment to support the implementations through the networking unit and the I/O device unit.

The embodiments disclosed herein can be implemented through at least one software program running on at least one hardware device and performing network management functions to control the elements. FIGS. 1 through 9 include blocks, which can be at least one of a hardware device or a combination of hardware device and software module.

The embodiments herein may be utilized in conjunction with the manufacture of integrated circuits, chip sets, or system-on-chips (SoCs). Regarding integrated circuits in general, a plurality of identical die are typically formed in a repeated pattern on a surface of a semiconductor wafer. Each die may include other structures or circuits. The individual die are cut or diced from the wafer, then packaged as an integrated circuit. One skilled in the art would know how to dice wafers and package die to produce integrated circuits. Integrated circuits so manufactured are considered part of this disclosure.

Although the embodiments herein have been shown and described with reference to certain embodiments, it will be understood by those skilled in the art that various changes in form and detail may be made therein without departing from the sprit and scope of this disclosure as defined by the appended claims.

What is claimed is:

1. A method for preserving a radio resource control (RRC) state of a user equipment (UE), the method comprising:
receiving, at the UE, from a radio network controller, a physical channel reconfiguration message for transitioning the RRC state of the UE;
detecting a circuit switching (CS) event at the UE; and
transmitting, from the UE, to the radio network controller, a physical channel reconfiguration failure message associated with a failure cause to preserve the RRC state of the UE.

2. The method of claim 1, wherein the failure cause is one of ‘CS establishment ongoing’, ‘configuration unsupported’, and ‘incompatible simultaneous reconfiguration’.

3. The method of claim 1, wherein the physical channel reconfiguration message is received before, after, or simultaneous with detection of the CS event.

4. The method of claim 1, wherein the physical channel reconfiguration message is transmitted by the radio network controller upon expiration of an inactivity timer at the radio network controller.

5. The method of claim 1, wherein the physical channel reconfiguration message is transmitted by the radio network controller while the UE transmits an initial direct transfer (IDT) request for initiation of the CS event.

6. The method of claim 1, wherein the RRC state is one of a cell dedicated channel (CELL DCH) state and a cell forward access channel (CELL FACH) state.

7. The method of claim 6, wherein the physical channel reconfiguration message is transmitted by the radio network controller for transitioning the RRC state of the UE to one of a cell paging channel (CELL PCH) state and a UTRAN registration area (URA) paging channel (URA PCH) state.

8. The method of claim 6, wherein the radio network controller is configured to return to one of the CELL DCH state and the CELL FACH state in response to receiving the physical channel reconfiguration failure message associated with the failure cause.

9. A user equipment (UE) for preserving a radio resource control (RRC) state of the UE, the UE comprising:
a controller module configured to:
receive, from a radio network controller, a physical channel reconfiguration message for transitioning the RRC state of the UE;
detect a circuit switching (CS) event at the UE; and
transmit, to the radio network controller, a physical channel reconfiguration failure message associated with a failure cause to preserve the RRC state of the UE.

10. The UE of claim 9, wherein the failure cause is one of ‘CS establishment ongoing’, ‘configuration unsupported’, and ‘incompatible simultaneous reconfiguration’.

11. The UE of claim 9, wherein the physical channel reconfiguration message is received before, after, or simultaneous with detection of the CS event.

12. The UE of claim 9, wherein the physical channel reconfiguration message is transmitted by the radio network controller upon expiration of an inactivity timer at the radio network controller.

13. The UE of claim 9, wherein the physical channel reconfiguration message is transmitted by the radio network controller while the UE transmits an initial direct transfer (IDT) request for initiation of the CS event.

14. The UE of claim 9, wherein the RRC state is one of a cell dedicated channel (CELL DCH) state and a cell forward access channel (CELL FACH) state.

15. The UE of claim 14, wherein the physical channel reconfiguration message is transmitted by the radio network controller for transitioning the RRC state of the UE to one of a cell paging channel (CELL PCH) state and a UTRAN registration area (URA) paging channel (URA PCH) state.

16. The UE of claim 14, wherein the radio network controller is configured to return to one of the CELL DCH state and the CELL FACH state in response to receiving the physical channel reconfiguration failure message associated with the failure cause.

17. A computer program product comprising a computer executable program code recorded on a non-transitory computer-readable storage medium, the computer executable program code, when executed, causing actions including:
receiving, from a radio network controller, a physical channel reconfiguration message for transitioning a radio resource control (RRC) state of a user equipment (UE);
detecting a circuit switching (CS) event at the UE; and
transmitting, to the radio network controller, a physical channel reconfiguration failure message associated with a failure cause to preserve the RRC state of the UE.

18. A system-on-chip for preserving a radio resource control (RRC) state of a user equipment (UE), the system-on-chip configured to:
receive, from a radio network controller, a physical channel reconfiguration message for transitioning the RRC state of the UE;
detect a circuit switching (CS) event at the UE; and
transmit, to the radio network controller, a physical channel reconfiguration failure message associated with a failure cause to preserve the RRC state of the UE.

19. A method for preserving a radio resource control (RRC) state of a user equipment (UE), the method comprising:
transmitting, from a radio network controller, to the UE, a physical channel reconfiguration message for transitioning the RRC state of the UE;
receiving, at the radio network controller, from the UE, a physical channel reconfiguration failure message associated with a failure cause to preserve the RRC state of the UE; and
returning a state of the radio network controller to one of a cell dedicated channel (CELL DCH) state and a cell forward access channel (CELL FACH) state in response to receiving the physical channel reconfiguration failure message associated with the failure cause.

20. A base station for preserving a radio resource control (RRC) state of a user equipment (UE), the system comprising:
a transceiver configured to transmit, to the UE, a physical channel reconfiguration message for transitioning the RRC state of the UE, and receive, from the UE, a physical channel reconfiguration failure message associated with a failure cause to preserve the RRC state of the UE; and
a radio network controller configured to return a state of the radio network controller to one of a cell dedicated channel (CELL DCH) state and a cell forward access channel (CELL FACH) state in response to receiving the physical channel reconfiguration failure message associated with the failure cause.
